(19) United States
(12) Patent Application Publication
(10) Pub. No.: US 2026/0138176 A1
(43) Pub. Date: May 21, 2026

(54) MALE THREAD REPAIR TOOL

(71) Applicant: Yulia USPENSKAYA, Winsen (DE)

(72) Inventor: Philipp Sebastian SILBERKUHL, Moscow (RU)

(21) Appl. No.: 18/865,874

(22) PCT Filed: May 23, 2022
(86) PCT No.: PCT/RU2022/000172

§ 371 Date: Jul. 2, 2025

(51) Int. Cl. B21H 3/04; B23G 7/02; B23G 9/00

(52) U.S. Cl. CPC B21H 3/042; B23G 7/02; B23G 9/009

(57) ABSTRACT

The invention relates to means for repairing male threads. The thread repair tool (1) comprises the first tool body (2), the second tool body (3), and the rollers (4, 6) installed on said tool bodies (2, 3), respectively. The first tool body (2) and the second tool body (3) are movably connected to each other at their first ends (2.1, 3.1), and each said tool body (2, 3) has a cambered shape thus forming a ring-like shape when the thread repair tool (1) is in a closed state. The technical result of the invention is repairing a male thread upon re-forming a material of the thread and avoiding cutting thereof, while keeping a diameter of the male thread of a required value.

The invention relates to means for repairing male threads.

Repairing male threads, or external threads, especially small ones, is known to be a complicate task. Not always a workpiece with a damaged, i.e. having imperfections, male thread can be replaced with a new one due to long lead times or high total costs. Another concern of most of the known repairing tools is that these do not carry out repairing a damaged thread as such. Rather, a damaged thread is cut by said tools to make the thread workable again. Obviously, cutting the damaged thread results in removing a portion of a material the thread is made of, thus causing weakening the repaired thread, especially that one of a small pitch. Another concern is that the repaired thread has a somewhat smaller diameter than required.

The closest analogue of the pending invention is the thread rolling tool disclosed in U.S. Pat. No. 10,543,524 B2 and aimed at repairing or rolling male threads. The known tool comprises the base body and the arm connected thereto by means of a snap connection. In the base body the slide is movably installed. When the base body and the arm are closed, the slide body may be moved forth and back, or to and from the arm, respectively, by means of the set screw. The base body is provided with two counter rollers and the slide body is provided with the profiled roller. Said rollers perform repairing a damaged male thread upon closure of the tool and applying rotation thereto around said thread. The advantage of the closest analogue over the other known tools of this kind is high functionality. It can be used for a wide range of male threads, yet allows reducing the effect of cutting a thread being repaired.

The disadvantage of the closest analogue is that in some cases a diameter of the repaired thread appears to be smaller than the required, e.g. according to the ISO standard, as too much material was moved in attempt to restore an initial shape of the thread. However, a tooth of the tread can still remain in accordance with the ISO standard, meaning that it is fully formed even though the diameter becomes smaller than the required or prescribed. Apart from other reasons, this is due to that in the known tool a working plane defining an effective working direction of the rollers is parallel to the set screw moving the slide with the profiled roller installed thereon. Here the working plane is always in a constant position.

Further, the shape of the closest analogue is not that suitable for using the thread repair tool with external tools such as electric screwdrivers that may be required in certain cases. For instance, if a male thread to be repaired is made of a hard material, use of an electric screwdriver could be preferential over operating the tool by hand in terms of time and efforts necessary for repairing the male thread with a required quality.

Thus, the objective of the present invention is providing a thread repair tool for repairing male threads that eliminates disadvantages of the known tools, allowing merely re-forming a thread profile back rather than cutting it while keeping a required diameter of the thread and providing a possibility to easy use external tools for operating the claimed thread repair tool

The technical result of the invention is repairing a male thread upon re-forming a material of the thread and avoiding cutting thereof, while keeping a diameter of the male thread of a required value.

For achieving said objective and technical result, a thread repair tool for repairing a male thread comprises a first tool body, a second tool body, at least one first roller installed on the first tool body, and at least two second rollers installed on the second tool body. The first tool body and the second tool body are movably connected to each other at their first ends, and each said tool body has a cambered shape thus forming a ring-like shape when the thread repair tool is in a closed state.

Although the claimed thread repair tool equipped with the first and second rollers of a given diameter and a given pitch allows repairing a male thread of substantially a particular diameter and a particular pitch, it has proven to re-form the male thread fully keeping a required diameter thereof. Contrary to the closest analogue, the working plane of the claimed tool is moving when one starts closing the first and second tool bodies, thanks to the cambered shape of said bodies.

Some of said first and second rollers may be made floating along axes they are mounted on. It will allow a user to better control the initial engagement of the rollers with the thread to be repaired.

Further, the thread repair tool may be provided with a fixing means to safely and precisely fix the first tool body against the second tool body in the closed state of the claimed tool, thus providing a more accurate treating the thread to be repaired. In particular, the fixing means may be made in the form of a screw, though other variants are also possible.

Besides, the thread repair tool may be provided with a stop for fixing the first tool body and the second tool body in any intermediate relative position, e.g. for carrying out initial treatment of the thread to be repaired, followed by full closure of the tool for final treatment.

It is also preferable if the first tool body and the second tool body each is provided with a hex head portion at a side surface thereof, said hex head portions forming a closed hex head shape when the thread repair tool is in the closed state. It will make the claimed tool more convenient for using with external tools such as electric screwdrivers or the like.

Further, at least one of said rollers may be configured to vibrate, preferably at a frequency of up to 20 kHz or more. This provides for a more accurate and precise repairing of the male thread and in some cases such as printed threads increases a density thereof, especially for the threads made of a hard material, as well as helps to homogenize a structure of the material of the male thread.

The invention is further described in more detail with reference to the enclosed figures wherein:

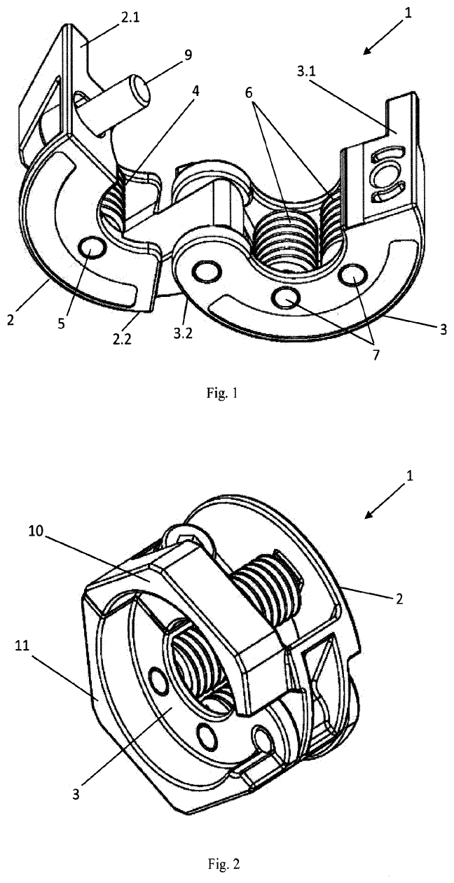

FIG. 1 provides a general view of the claimed thread repair tool in an open state;

FIG. 2 provides a general view of the claimed thread repair tool in a closed state;

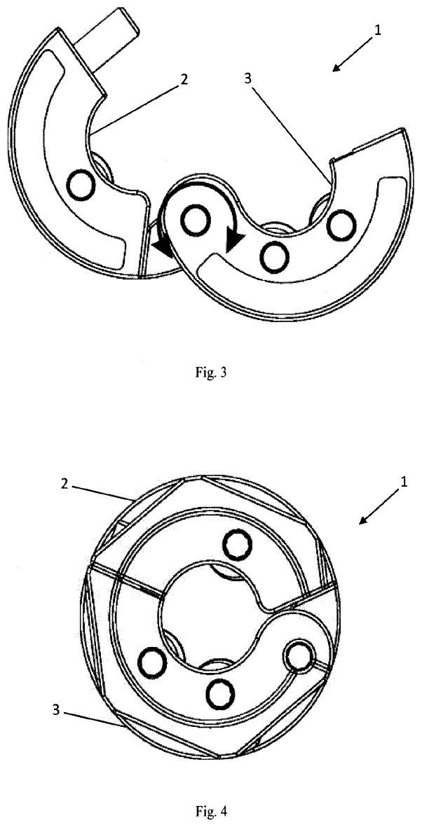

FIG. 3 provides a side view of the claimed thread repair tool in the open state;

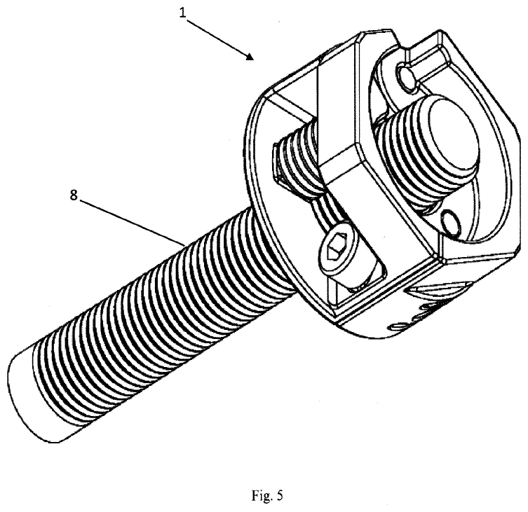

FIG. 4 provides a side view of the claimed thread repair tool in the closed state;

FIG. 5 provides a general view of the claimed thread repair tool in use.

A thread repair tool 1 comprises a first tool body 2 and a second tool body 3 movably connected to each other at their first ends 2.1 and 3.1, respectively, as shown in FIG. 3 by an arrow. Second ends 2.2 and 3.2 of said first tool body 2 and second tool body 3, respectively, are free for movement.

FIG. 1 depicts an open state of the thread repair tool 1 when the second ends 2.2 and 3.2 are distant from each other, while in FIG. 2 the thread repair tool 1 is shown in a closed state thereof when the second ends 2.2 and 3.2 are next to each other, preferably in contact with each other.

Both the first tool body 2 and the second tool body 3 have a similar curved shape, or a cambered shape. To be more specific said tool bodies 2, 3 each has substantially a half ring-like shape, as better seen in FIG. 3, so that when the thread repair tool 1 is in the closed state it has a ring-like shape, as shown in FIG. 4.

The first tool body 2 comprises at least one first roller 4 installed thereon, e.g. by means of a pin 5 or the like. The first roller 4 is made rotatable around an axis thereof (or an axis of the pin 5) and, additionally but not necessarily, may move along said axis, i.e. be floating to better control initial engagement of the roller 4 with a thread to be repaired.

The second tool body 3 comprises at least two second rollers 6 installed thereon, e.g. by means of pins 7 or the like. Each of the second rollers 6 is made rotatable around an axis thereof (or an axis of the respective pin 7) and additionally, but not necessarily, may move along said axis, i.e. be floating to better control initial engagement of the roller 6 with a thread to be repaired. Each of said rollers 4, 6 are provided with a thread on their outer surfaces merely corresponding to a male thread under reparation in terms of a diameter and a pitch of the male thread to be achieved.

Although one first roller 4 and two rollers 6 are enough for repairing a male thread, more rollers may be advantageous e.g. when a diameter of the male thread is high or the male thread is made of a hard material.

To repair a male thread 8 (see FIG. 5), the thread repair tool 1 is opened, and the male thread 8 is disposed between the rollers 4, 6. Then the thread repair tool 1 is closed so that the rollers 4, 6 come in a contact with the male thread 8, and rotation is applied to the thread repair tool 1. Just few turns may be sufficient for repairing the male thread 8. However, more turns may be required depending on the level of damage of the male thread 8, a material the male thread 8 is made of and some other factors.

If the rollers 4, 6 are made interchangeable, the thread repair tool 1 may be used for male thread of different diameters. In this case a user replaces the rollers 4, 6 with those ones of required diameter and pitch, and proceeds with repairing the male thread 8 as described above.

Generally, reparation of the male thread 8 is carried out when the thread repair tool 1 is in the completely closed state, as shown in FIGS. 2, 4, 5. For the purpose of safe fixing the thread repair tool 1 in this position, a fixing means 9 may be provided at the second end 2.2 of the first tool body 2 and/or the second end 3.2 of the second tool body 3. For instance, the fixing means 9 may be a screw, as shown in FIGS. 1, 5.

It may be preferable, though, if a first turn (or first few turns) is carried out when the thread repair tool 1 is not completely closed, i.e. a gap exists between the second end 2.2 and the second end 3.2. For instance, it could be an option for hard materials or male threads of large size when a step-by-step reparation is preferable. In this case, the thread repair tool 1 may be provided with a stop (not shown in the figures) allowing fixing a relative position of the tool bodies 2, 3.

Besides or in addition thereto, the thread repair tool 1 may be provided with a means for connecting to (engaging) an external tool available in the market such as mechanic or electric screwdrivers. For this purpose, said means may be hex head portions 10, 11 provided on side surfaces of the first tool body 2 and the second tool body 3, respectively. When the thread repair tool 1 is in the closed position, said hex head portions 10, 11 form a closed hex head shape, as shown in FIGS. 2, 5. Using the external tool engaged said hex head allows to apply a higher force to the thread repair tool 1, yet more evenly and precisely which will positively affect a shape of the repaired male thread.

It is preferable if the claimed thread repair tool 1 is designed so that at least one of the rollers 4, 6 is configured to vibrate, preferably at a frequency of up to 20 kHz or more. Said vibration may be carried out substantially in a direction perpendicular to the pins 5, 7, i.e. perpendicular to an axis of the male thread 8 being repaired and axes of the pins 5, 7, or substantially in a direction along said axes of the male thread 8 and the pins 5, 7, or in a combination of said directions. An amplitude of said vibration may be small, e.g. smaller than a pitch of the male thread 8.

Said vibration may be provided by any vibrating means (not shown in the figures), or an actuator, which will be obvious for a skilled person. For example, the actuator may be incorporated into the claimed thread repair tool 1, connected to at least one of the pins 5, 7 and forcing the respective pin(s) 5, 7 to vibrate in any of the directions mentioned above. Alternatively, the vibrating means may be any suitable external tool, e.g. a specifically designed electric screwdriver having a dedicated mechanism that comes into contact with or engages the respective pin(s) 5, 7 and causes the latter to vibrate. Other variants of forcing the at least one pin 5, 7 to vibrate are also possible, though. Obviously, the vibrating pin(s) 5, 7 shall be configured for allowing movement in the required direction.

In fact, this is a reciprocal vibration of the first roller 4 and the second rollers 6 with a small amplitude and a relatively high frequency. It provides for a more accurate and precise repairing of the male thread 8, especially that one made of a hard material, and also helps to homogenize a structure of the material and in some cases to increase a density of the male thread 8 by cracking large pieces like carbide islands within the male thread 8 into small islands thus increasing density of the material of the male thread 8.

Thus the claimed thread repair tool for male threads allows at once re-forming a thread profile back rather than cutting it, keeping a required diameter of the thread, and easy use external tools for operating the claimed thread repair tool.

1. A thread repair tool for repairing a male thread, comprising:
a first tool body having a first end and a second end;
a second tool body having a first end and a second end;
at least one first roller installed on the first tool body;
and at least two second rollers installed on the second tool body,
wherein the first tool body and the second tool body are movably connected to each other at said first ends thereof, providing an open state and a closed state the thread repair tool when said second ends are distant from each other and next to each other, respectively, and
wherein the first tool body and the second tool body each has a cambered shape so as to form a ring-like shape when the thread repair tool is in the closed state.

2. The thread repair tool of claim 1, wherein at least one of said at least one first roller and said at least two second rollers is made floating.

3. The thread repair tool of claim 1, further provided with a fixing means located at the second end of the first tool body and/or the second end of the second tool body.

4. The thread repair tool of claim 3, wherein the fixing means is made in a form of a screw.

5. The thread repair tool of claim 1, further provided with a stop for fixing a relative position of the first tool body and the second tool body.

6. The thread repair tool of claim 1, wherein the first tool body and the second tool body each is provided with a hex head portion at side surfaces thereof, said hex head portions forming a closed hex head shape when the thread repair tool is in the closed state.

7. The thread repair tool according to claim 1, wherein at least one of said rollers is configured to vibrate at a given frequency.

8. The thread repair tool according to claim 7, wherein said given frequency is up to 20 KHz.
